(19) United States
(12) Patent Application Publication
(10) Pub. No.: US 2003/0012500 A1
(43) Pub. Date: Jan. 16, 2003

(54) Container for optical fibre components

(76) Inventor: Guido Oliveti, Torino (IT)

Correspondence Address: Corning Incorporated, SP TI 03, Corning, NY, 14831, US

(21) Appl. No.: 10/168,783

(22) PCT Filed: Dec. 14, 2000
(86) PCT No.: PCT/EP00/12876

(30) Foreign Application Priority Data
Dec. 28, 1999 (EP) 99126057.1

(51) Int. Cl. G02B 6/34

(52) U.S. Cl. 385/37

(57) ABSTRACT

Structure capable of compensating for the effects of temperature variations on an optical fibre component, the said optical fibre component having at least a first end (92) and at least a second end (93). In particular, the said structure comprises: a first support capable of fixing the said first end (93) of the optical fibre component (9), a second support capable of fixing the said second end (92) of the optical fibre component (9), a central element (4) which connects the said first support to the said second support, having a coefficient of thermal expansion greater than that of both the said first support and the said second support, in such a way as to cause a variation of the distance between the said two ends of the component as the temperature varies.

The present invention relates to a container for optical fibre components, comprising within it a structure for compensating for the effects of variations of temperature on the optical fibre component in question.

A container of this type can be used for optical fibre components whose spectral response varies in its wavelength as a result of variations of temperature.

Some examples of these optical fibre components are components comprising at least one Bragg grating scribed in the fibre, such as a wavelength selective filter or a wavelength selective coupler or a device for injecting and extracting an optical signal, formed in an optical fibre comprising a Bragg grating.

Bragg gratings in optical fibres are formed by an alternation of areas with high refractive index and areas with a low refractive index. The distance between these areas is called the grating period. The grating period determines which wavelengths are reflected and which are transmitted.

Patent application W09636895 describes a method for scribing this type of grating in an optical fibre.

The temperature dependence of Bragg gratings is related to the variations of the refractive index of the region guiding the optical beam which passes through the grating (thermo-optical effect) and to the variations of the tension of the fibre. Typically, the thermo-optical effect provides the major contribution, and for optical materials the thermo-optical coefficient is positive. In silica, for example, it is of the order of +11×10⁻⁶/° C. Fibre components based on Bragg gratings show a temperature-induced wavelength shift of approximately 0.01 nm/° C.

This dependence limits the use of the said components in applications in which a high spectral stability is required, such as applications in dense wavelength division multiplexing telecommunications systems. In particular, for applications with a spacing between the transmitted channels which form the multiple-wavelength signal at, for example, 100 GHz (in other words, with channels approximately 0.8 nm apart in the transmission window around 1500 nm), the system specifications might require a thermal stability of more than 0.001 nm/° C in the channel filters.

The dependence of the wavelength of the reflection (or transmission) peak of the spectral response of a grating in an optical fibre on its temperature is determined by the following expression:

$$\frac{1}{λ} \frac{\partial λ}{\partial T} = \frac{1}{n} \frac{δ n}{δ T} + α + \frac{1}{n} \frac{δ n}{δϵ} \frac{δϵ}{δ T} + \frac{1}{Λ} \frac{δΛ}{δϵ} \frac{δϵ}{δ T} \qquad ( 1 )$$

where n is the value of the refractive index, α is the value of the coefficient of thermal expansion, and ε is the value of the tension applied to the fibre. Λ is the modulation period, in the longitudinal direction, of the refractive index which defines the grating. The first term of this formula includes the thermo-optical coefficient δn/δT, and represents the variation of the refractive index with the variation of temperature, the second term of this formula is the coefficient of thermal expansion of the optical fibre, the third term of this formula includes the elasto-optical coefficient δn/δε and represents the variation of the refractive index with the tension, and the final term of this formula represents the variation of the period of the Bragg grating with the variation of the tension applied to the optical fibre.

Various methods have been proposed for stabilizing the effects of temperature on optical fibre components.

One of these methods is described, for example, in patent application EP0795766 in the name of the present applicant. This application describes an apparatus for protecting optical fibre devices, comprising a casing and a housing passing through the said casing in which a length of optical fibre is inserted so that it is located inside the said casing.

The apparatus also comprises sealing means interposed between the said housing and the said casing, in which the said housing is delimited in an impervious way with respect to the said casing. In particular, the said housing is made from material with low thermal conductivity, and its thermal conductivity in the longitudinal direction parallel to the axis of passage is lower than its thermal conductivity in the transverse direction.

The applicant has observed that, in this patent application, the optical fibre device is protected by actively keeping the temperature of the device constant by means of an electronic control system.

U.S. Pat. No. 5,123,070 describes a method in which the thermo-optical coefficient of a grating scribed in a waveguide is suitably modified in such a way as to compensate for the effects induced by temperature variations. The guide comprises a plurality of layers of dielectric with self-compensating thermo-optical coefficients. The guide is formed by sequential deposition of dielectric layers. The first layer is SiO₂, while the second, made from Ta₂O₅, has a negative thermo-optical coefficient.

The applicant has observed that this method entails the difficult task of forming an optical material which has a suitable value of this negative thermo-optical coefficient, while keeping the other optical properties required for a waveguide unchanged.

One method of stabilizing the spectral response of an optical fibre grating is that of fixing the said grating to a substrate, or more generally a support, in such a way that the actual thermal expansion of the assembly consisting of the fibre grating and its support becomes negative and is capable of compensating for the normal positive contributions of the thermooptical and elasto-optical coefficients.

In the case of an optical fibre in tension, the preceding equation (1) becomes:

$$\frac{1}{λ} \frac{\partial λ}{\partial T} = \frac{1}{n} \frac{δ n}{δ T} + {α}_{s} - \frac{1}{n} \frac{δ n}{δϵ} {α}_{f} \qquad ( 2 )$$

where αₛ and α_{f} are, respectively, the coefficients of thermal expansion of the substrate, or support, and of the fibre.

In the method for compensating for the effects of temperature on a Bragg grating described in U.S. Pat. No. 5,694,503, a substrate is formed from a material having a negative coefficient of thermal expansion. The optical fibre is mounted under tension on the substrate. By selecting and/or designing a material for the substrate with a suitable value of the coefficient of thermal expansion, the variation of tension induced in the fibre compensates for the positive contributions of the thermo-optical and elasto-optical coefficients of the optical fibre. The applicant has observed that in this method it is necessary to form a material with a well-defined value of the negative coefficient of thermal expansion, by modifying its chemical or structural composition, and that the method does not allow fine adjustments of the passive compensation action. Moreover, the material used as the substrate must be sufficiently robust and resistant to degradation of the mechanical properties over time.

In the method for compensating for temperature effects on a Bragg grating described in U.S. Pat. No. 5,841,920, a substrate consists of two materials of different length which have different positive coefficients of thermal expansion. The shorter of these is made from the material with the higher coefficient of thermal expansion, while the longer is made from the material with the lower coefficient of thermal expansion. By placing one of the two pieces of material on top of the other and fixing the two ends which coincide with each other, a structure is obtained in which the other two free ends approach each other as the temperature increases. When the optical fibre is mounted in tension between the latter two ends, its effective coefficient of thermal expansion becomes negative.

The applicant has observed that, in this method, the useful length of the support, in other words the length of the fibre on which it acts, is less (50-70%) than the total overall length of the supporting structure. This makes it necessary to produce a container whose dimensions are 30-50% greater than the actual overall dimensions of the optical fibre component.

The present invention is applicable to optical fibre components in which the variations of the wavelength of the spectral response caused by the aforesaid thermo-optical coefficient can be compensated by varying the tension in the fibre which contains the component.

The applicant has tackled the problem of reducing the overall dimensions of a container for optical fibre components, in which the effects of temperature on the spectral response of the component are compensated, with respect to the overall dimensions of the component.

The applicant has also tackled the problem of making a container in which the adjustments made to the substrate to determine its thermal expansion are made according to the type of fibre component which is housed in it, and are made after the component has been fixed to a structure for compensating for the effects of temperature variations, which is subsequently inserted into the container. This would make it possible to use the same container for different types of optical fibre components without having to modify the structure and/or geometry of the container.

In particular, the applicant has invented a container for optical fibre components which comprises a first support to which one end of the optical fibre component is fixed, a second support to which the other end of the optical fibre component is fixed, and a central element which has a higher coefficient of thermal expansion than the two supports, in such a way that the distance between the said two ends of the component decreases as the temperature increases, thus compensating for the thermo-optical effects on the component.

In particular, this component is fixed to a substrate, or more generally a support, in such a way that the actual thermal expansion of the assembly consisting of the fibre component and the support becomes negative.

In one of its aspects, the present invention relates to a structure capable of compensating for the effects of temperature variations on an optical fibre component, the said optical fibre component having at least a first end and at least a second end, characterized in that the said structure comprises:

a first support capable of fixing the said first end of the optical fibre component,

a second support capable of fixing the said second end of the optical fibre component,

a central element which connects the said first support to the said second support, having a coefficient of thermal expansion greater than that of both the said first support and the said second support, in such a way as to cause a variation of the distance between the said two ends of the component as the temperature varies.

Preferably, the said first support, the said second support and the said central element are at least partially superimposed on each other.

In particular, the said central element comprises a first portion connected to the said first support, a central portion which is free to change its length as a result of temperature variations, and a second central portion connected to the said second support.

Preferably, the said first portion of the central element has a modifiable length.

Preferably, the said second portion of the central element has a modifiable length.

Preferably, the said first support and the said second support have essentially the same coefficient of thermal expansion.

In particular, the said first support is a base support comprising, at one of its ends, a block on whose upper surface there is at least one V-shaped notch into which one end of the said component can be inserted.

In particular, the said second support is an upper support comprising, at one of its ends, a platform on which there is at least one V-shaped notch into which one end of the said component can be inserted.

In particular, the said central element comprises, in the said first portion, a first protuberance, which projects downwards, and is inserted into a hole in the said base support, and, in the said second portion, a second protuberance which projects upwards, and is inserted into a hole in the said upper support.

In a further aspect, the present invention relates to a temperature-compensated optical fibre device, comprising the said compensation structure and an optical fibre component fixed to it.

In a further aspect, the present invention relates to a container for optical fibre components, comprising an outer casing into which the said structure for compensating for the effects of temperature variations is inserted.

In a further aspect, the present invention relates to a method for compensating for the effects of temperature variations on an optical fibre component, the said optical fibre component having at least a first end and at least a second end, comprising the following stages:

fixing the said first end to a first support,

tensioning the said component with a predetermined degree of tension;

fixing the said second end to a second support, connected to the said first support by means of a central element, the said central element comprising a first portion fixed to the said first support, a central portion free to change its length as a result of temperature variations, and a second central portion fixed to the said second support,

characterized in that it additionally comprises the stage of:

adjusting the length of the said central portion of the said central element.

Preferably, the said stage of adjusting the length of the said central portion comprises welding the central element to the said first support in such a way as to extend the fixing area between the said first support and the said central element.

Preferably, the said stage of adjusting the length of the said central portion comprises welding the central element to the said second support in such a way as to extend the fixing area between the said second support and the said central element.

Further characteristics and advantages of the present invention can be found in greater detail in the following description, with reference to the attached drawings, provided solely for the purpose of explanation and without any restrictive intent, which show:

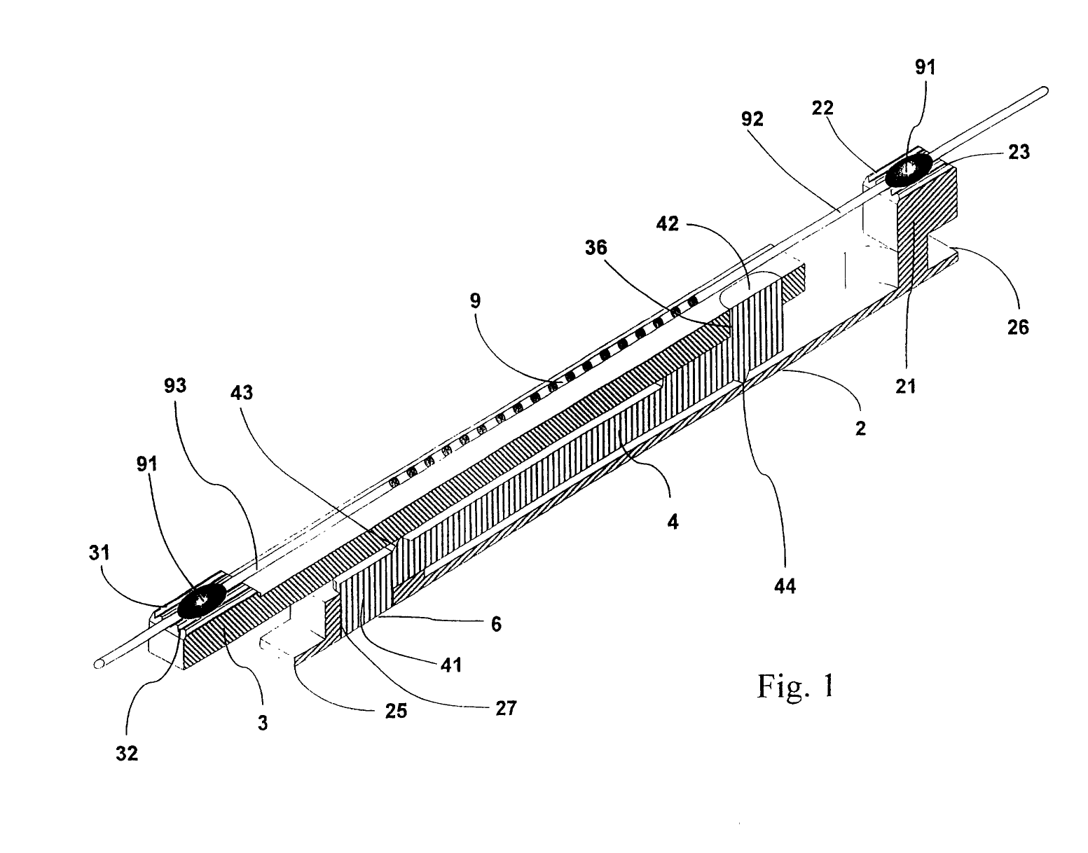

in FIG. 1, a longitudinal section through a structure for compensating for the effects of temperature in an optical fibre component fixed in it according to the present invention;

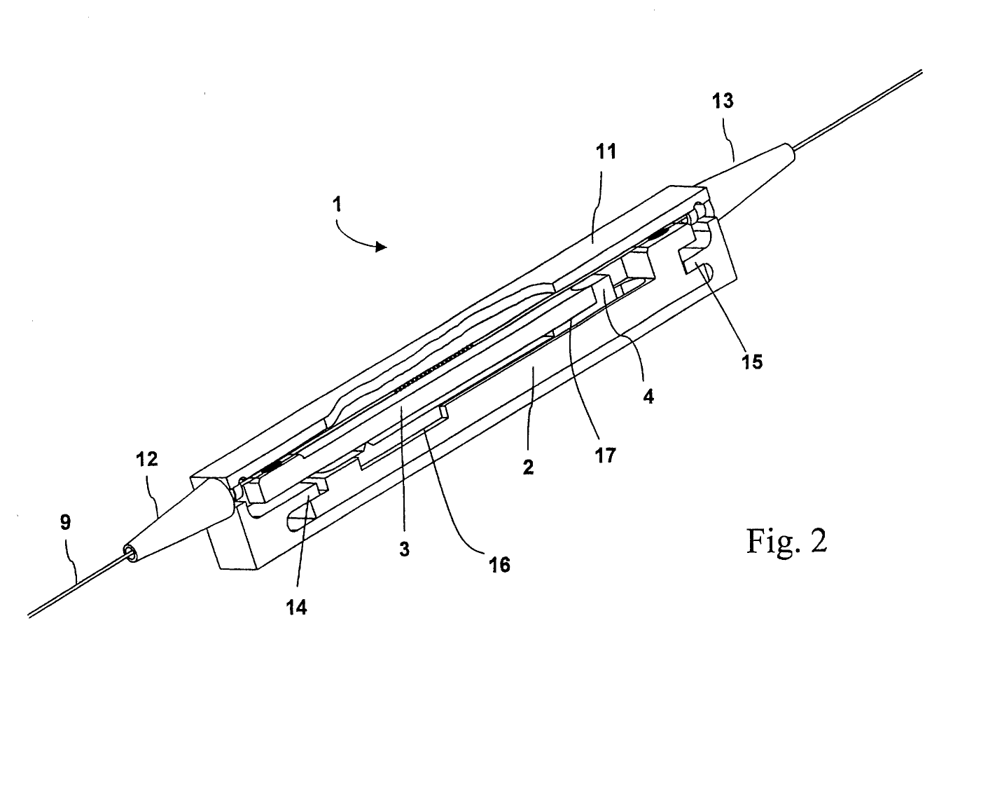

in FIG. 2, a section through a container for optical fibre components, including a structure for compensating for the effects of temperature according to the present invention;

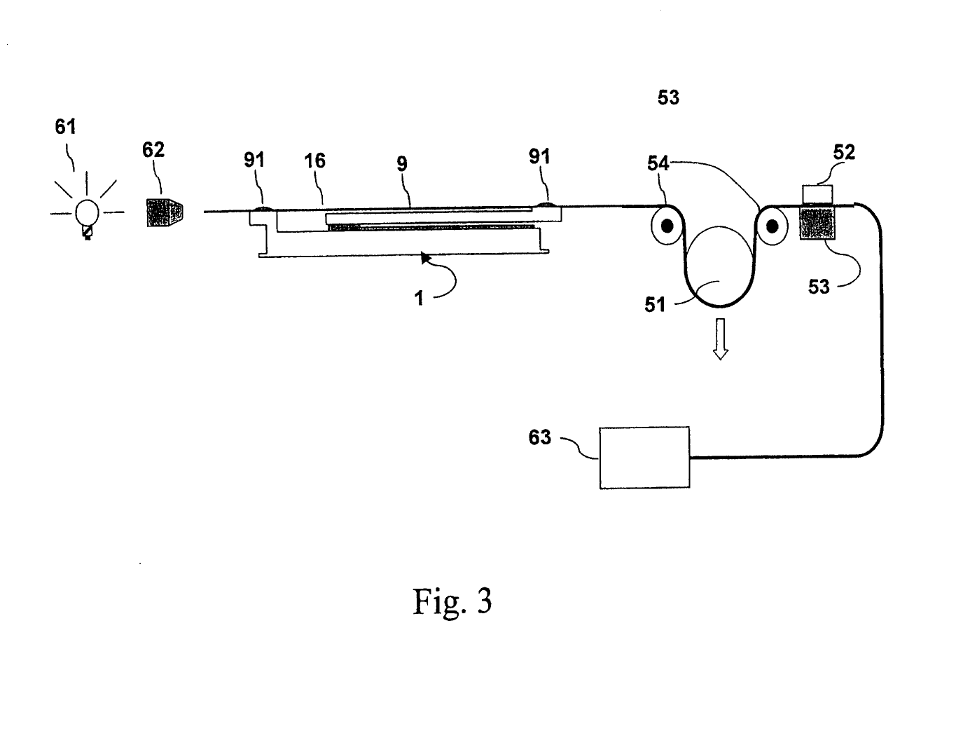

in FIG. 3, an apparatus for fixing an optical fibre component inside the structure for compensating for the effects of temperature of FIG. 1;

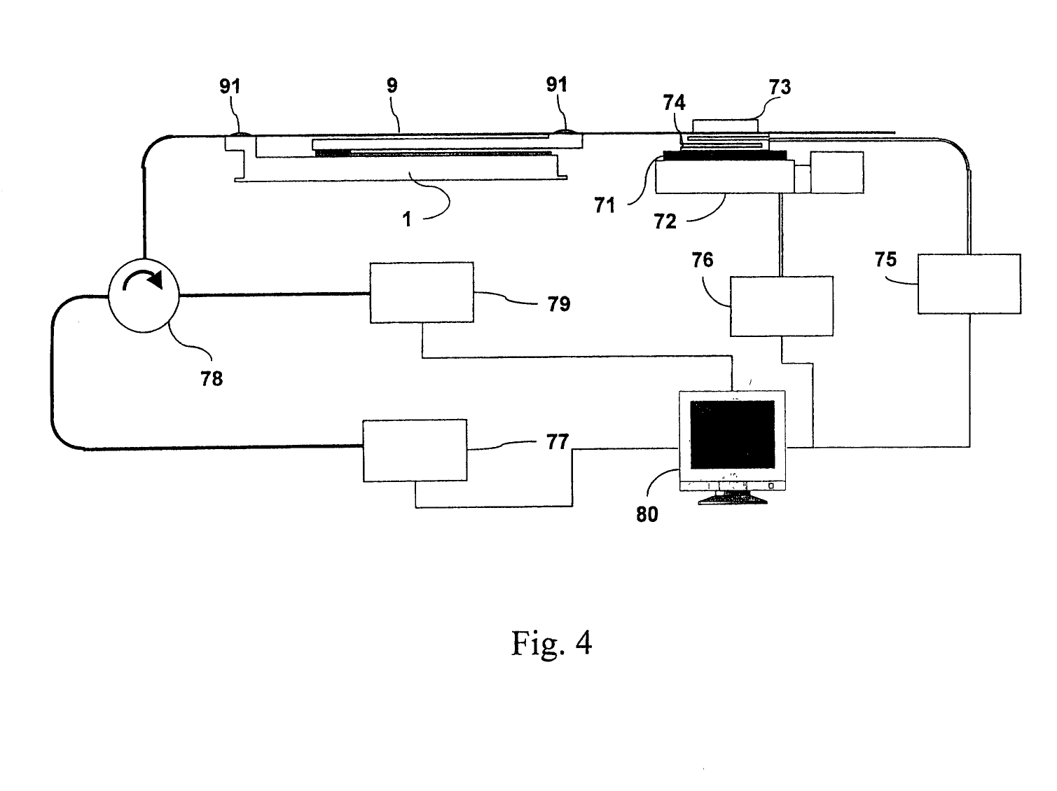

in FIG. 4, an apparatus for fixing and monitoring the operations of fixing an optical fibre component in the structure for compensating for the effects of temperature of FIG. 1;

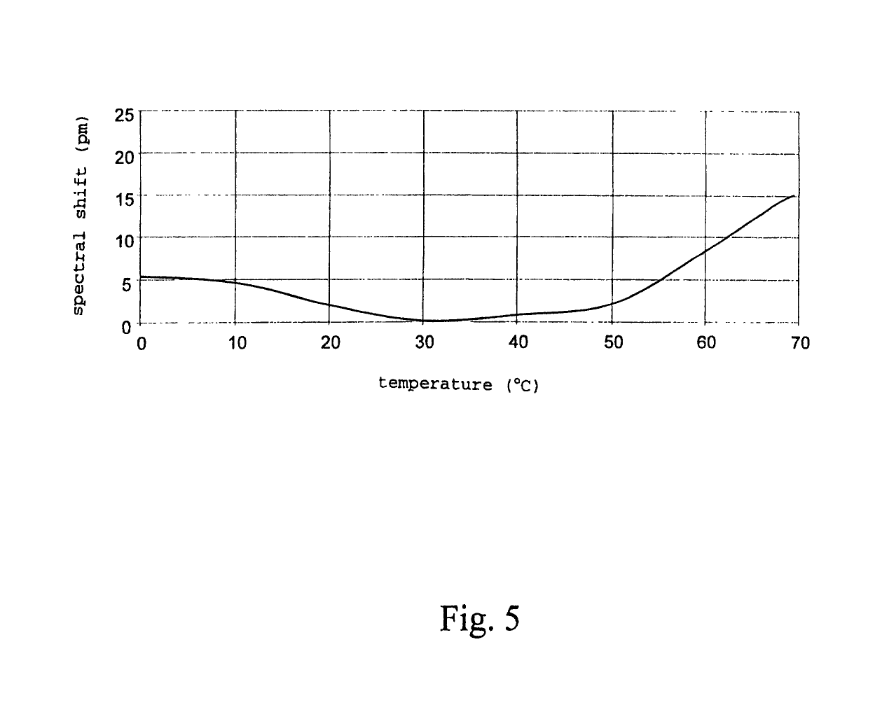

in FIG. 5, an experimental graph of the spectral response as a function of the variation of the temperature of an optical fibre component mounted on the compensation structure according to the present invention;

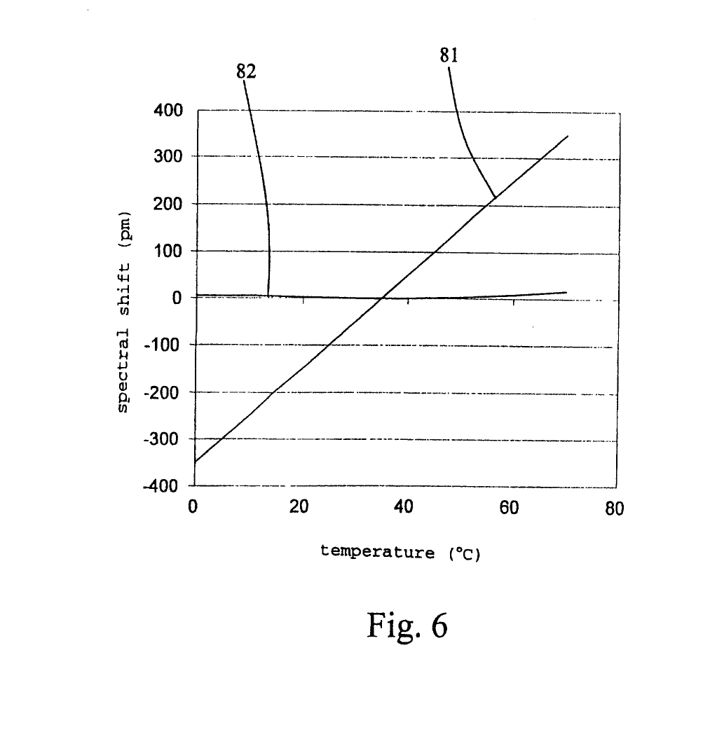

in FIG. 6, an experimental graph of the spectral response as a function of the variation of the temperature of an optical fibre component mounted on the compensation structure according to the present invention, compared with a graph of the spectral response as a function of the variation of the same component when it is not compensated.

FIG. 1 shows an embodiment of a structure for compensating for the effects of temperature, comprising three parts, an upper support 3, a central element 4, and a base support 2, assembled together by means of force-fitted mechanical joints.

In particular, the base support 2 is essentially parallelepipedal in shape, and has a block 21 at one of its ends. The upper surface 22 of the block 21 is a platform, and has a plurality of V-shaped notches 23 capable of holding a first end 92 of an optical fibre component 9. This component is, for example, a Bragg grating in an optical fibre, but the invention is equally applicable to other types of optical fibre components as described above. A further example of such an optical fibre component is a device of the Mach-Zehnder type, in which it is necessary to compensate for the variation of length of each branch with a variation in temperature. In this case, the compensation is not carried out in order to oppose the variation of the wavelength of the spectral response, but in order to compensate for the effect of elongation of the branches of the Mach-Zehnder device with an increase in temperature.

The number of components which can be fixed on the block is determined by the number of V-shaped notches.

The said end of the component 9 is fixed on the block by means of an epoxy resin 91, for example.

At the base of the said block 21 and at its opposite end, the base support 2 has a pair of tabs 25 and 26, enabling the support to be fixed inside the casing of the container (not shown in FIG. 1).

The upper support 3, also essentially parallelepipedal in shape, has at one of its ends a platform 31 on which there are a plurality of notches 32, which are V-shaped and essentially identical in number and shape to those on the block 21, and are suitable for the fixing of a second end 93 of the component 9. This end 93 of the component 9 is also fixed on the block by means of an epoxy resin 91, for example.

The central element 4, of essentially parallelepipedal shape, is positioned between the said base support and the said upper support, and has at one of its ends a first protuberance 41, which projects downwards and is inserted into a hole 27 of the said base support 2, and a second protuberance 42, essentially similar to the first but projecting upwards, located at the opposite end and inserted into a hole 36 in the said upper support 3. The hole 27 in the said base support 2 is preferably located at the opposite end of the base support to that having the block 21, and the hole 36 in the upper support 3 is preferably formed in an intermediate position of the support.

This central element 4 also has a first projection 43, which extends from its upper surface and makes contact with the lower surface of the upper support 3, and a second projection 44, which extends from its lower surface and which makes contact with the upper surface of the base support 2.

The base support 2 and the central element 4 are joined to each other by a first mechanical joint, preferably formed by the hole 26 into which the protuberance 41 is inserted, advantageously by a force-fitting method.

The upper support 3 and the central element 4 are joined to each other by a second mechanical joint, preferably formed by the hole 36 into which the protuberance 42 is inserted, advantageously by a force-fitting method.

Within the scope of the present invention, these force-fitting joints between the base support 2 and the central element 4, and between the upper support 3 and the central element 4, can be made by other means, such as fixing by means of screws or fixing by the use of epoxy adhesives with low thermal expansion or by laser welding. In any case, the force-fitted joints must provide thermal stability in the structure, in the sense that they must provide a permanent joint between the parts when the temperature varies.

Advantageously, the central element 4 is made from a material which has a coefficient of thermal expansion greater than the coefficient of thermal expansion of the material forming the base support 2 and the upper support 3, which are preferably both made from the same material.

In particular, with reference to FIG. 1, the base support 2 and the upper support 3, in other words the supports which have the fixing platforms for the fibre component 9, are made from materials, for example invar, having a lower coefficient of thermal expansion than the coefficient of thermal expansion of the material, for example aluminium or metal alloys such as AISI 309 or 310 steel, from which the central element 4 is made.

FIG. 2 shows the whole of a container 1 for optical fibre components, which has within it the said structure for compensating for the effects of temperature. In particular, there is shown an outer casing 11, preferably made from metallic material, for example aluminium, or alternatively from plastic material, for example glass-reinforced nylon. The ends of the optical fibre component 9 pass out of the container 1 through two grommets 12 and 13, preferably made form rubber, which attenuate the mechanical stresses on the fibre.

The compensation structure is fixed to the container 1 by means of two recesses 14 and 15 which engage with the aforesaid tabs 25 and 26 located on the base support 2.

The compensation structure operates in the following way.

The passive compensation action is provided by using materials having different physical characteristics, and particularly different coefficient of thermal expansion, for the elements which form the supporting structure of the optical fibre device.

In particular, when the temperature rises, the grating in an optical fibre changes its transfer function according to equations (1) and (2) shown above. In practice, the wavelength of the reflected optical signals increases with a rise in temperature. This effect can be compensated by a reduction of the period of the grating, and in particular by a reduction of the total length of the grating.

This reduction in length can be achieved by decreasing the distance between the two platforms 23 and 31. For this purpose, the central element is made from a material having a coefficient of thermal expansion greater than the coefficient of thermal expansion of the base support and of the upper support to which the ends of the optical fibre component are fixed.

As the temperature rises, the elongation of the central element is greater than that of the base support and of the upper support. The projections 43 and 44 on the central element 4 allow the essentially frictionless and parallel sliding of the three parts, resulting in a reduction of the distance between the two platforms 23 and 31 on which the ends of the optical fibre component 9 are fixed.

The optical fibre component is pre-tensioned when it is fixed on the structure for compensating for the effects of temperature. Thus, if the lengths of all the elements have been suitably predetermined, a rise in temperature is accompanied by a decrease in the distance between the fixing platforms and consequently a decrease in the tension applied to the optical fibre component 9 mounted between the said platforms. The decrease of the fibre tension compensates for the spectral shift, due to the rise in temperature, of the grating scribed on the fibre.

When the temperature decreases, the effect is the opposite of that described; in particular, the distance between the two platforms increases, and the tension of the optical fibre component increases, compensating for the spectral shift, due to the decrease in temperature, of the grating scribed on the said fibre.

The compensation action, both for a single optical fibre component and for N components, will be more efficient, precise and repeatable as the stability of the fixing of the ends of the fibre component to the structure increases, since the component is fixed under tension, and this imposes special constraints on the fixing method.

Various efficient fixing methods can be used. They may, for example, include epoxy resins, as described above, or alternatively “glass welding”. The preferable epoxy resins are those which have a high mechanical strength regardless of temperature variations and a low sensitivity to moisture. In the example, the component 9 was fixed to the two platforms 23 and 31 by two drops 91 of Epo-Tek H72 epoxy resin made by Epoxy Technology, Inc. Other fixing techniques, applicable where the optical fibre component is coated with metallic layers, include soldering by means of metallic alloys directly on to the platforms or with the use of metal ferrules (or other supports) which in turn are fixed to the platform by the laser welding technique.

FIG. 2 shows a preferred method for making a force-fitted joint between the three elements, which permits the adjustment of the compensation. In particular, a first contact area 16 between the base support 2 and the central element 4, and a second contact area 17 between the central element 4 and the upper support 3 are shown, in addition to the aforesaid force-fitted joints.

These contact areas 16 and 17 can be used for the fine adjustment of the compensating action of the structure. This is because, if the areas of fixing between the three parts are extended by micro-welds carried out, for example, by the laser welding system, the effective lengths of the three parts, in other words the areas which are free to expand as the temperature rises, will be decreased.

If the contact area 16 is modified, in other words if the effective length of the central element 4 is reduced, the passive compensation action is reduced, and consequently an under-compensation of the thermal effects on the optical fibre component is produced.

Conversely, if the contact area 17 is modified, in other words if the effective length of the upper support 3 is reduced, the passive compensation action will be increased, and consequently an over-compensation of the thermal effects on the optical fibre component will be produced. This fine adjustment of the passive compensation can be carried out even after the assembly of the optical fibre device on to the compensation structure. This provides a greater flexibility of the structure and makes it possible to optimize the performance of the final assembled device after it has been determined.

In general, the effective lengths of the three parts are selected in a suitable way, according to the sensitivity of the component to the effects of temperature variations. In particular, the central element has a first portion connected to the said base support, a central portion free to change its length under the effect of the temperature variations [connected] and a second central portion connected to the said upper support.

The length of this central portion can be modified by the said micro-welds.

The portions connected to the supports are restricted in their expansion by the supports themselves, since these supports have a lower coefficient of expansion, and consequently the variations of length of the said portions of the central element are not significant.

As stated above, the optical fibre component is pre-tensioned when it is fixed on the platforms 22 and 31.

The tension, suitably controlled, allows the central wavelength of the fibre grating to be adjusted accurately at the fixing stage, thus making it possible to rectify any inaccuracies in the fabrication of the grating with respect to the nominal operating wavelength of the component. A system of pulleys and weights such as that shown in FIG. 3 can be used to impart the desired tension to the fibre before fixing.

In particular, in the system in FIG. 3, the component 9 containing the grating is fixed by means of the epoxy resin 91 to one of the two platforms of the structure 1. In the present invention, this is equivalent to fixing a first end of the component to the base support, rather than to the upper support. A movable element 51, having a suitable weight in the range from a few grammes to several hundred grammes, stretches the component which, being retained by a fastening system 52 and 53, runs in the grooves of two pulleys 54. When the fibre has reached the desired tension, in other words when the central wavelength of the grating, measured by means of a monitoring system described below, is equal to the desired value, the fibre can be fixed to the structure 1 by means of a second drop of epoxy resin on the other platform of the structure.

The monitoring system shown in the figure comprises a wide-spectrum light source 61 (for example a halogen lamp or a superluminescent LED or a source of an amplified spontaneous emission spectrum), a device 62 for focusing the light emitted by the source on to the facet of the fibre component (for example, a system of lenses or a microscope objective) and an optical spectrum analyser 63 for the acquisition of the transmission spectrum of the component (for example the AQ6317 model, marketed by Ando Electric Co. Ltd., Japan).

Preferably, to obtain greater accuracy and repeatability of the procedure, it is possible to use a tensioning system which consists of electronically controlled motorized slides, which act directly on the fibre or through a system for measuring the tension to which the fibre is subjected, using load cells for example, as shown in FIG. 4.

In this case, the component is fixed in the following way:

The optical fibre component 9 containing the grating is fixed by means of the epoxy resin 91 to one of the two platforms of the structure 1.

A movable element 71 of a motorized movement device 72 (for example, the M-MFN25PP model marketed by Newport Corporation, USA) stretches the optical fibre component which is retained by a fastening system 73 integral with the movable element 71. A load cell 74 located on the said movement device 72 measures the tension of the component. The load cell is connected to an electronic circuit 75 for the processing and calibration of the output electrical signal. The motorized movement device is controlled and operated by an electronic circuit card 76 (for example, the MM2000 model marketed by Newport Corporation, USA).

Additionally, the end of the optical fibre component fixed to the platform is connected to a tunable laser 77 by an optical circulator 78. An optical spectrum analyser 79 is also connected to this circulator.

The optical circulator is positioned in such a way as to send the signal emitted by the laser 77 into the component 9 and to send the signal reflected by the component to the optical spectrum analyser 79.

The tunable laser 77 (for example, the 3642 CR00 model made by Photonetics, France) is capable of carrying out a wavelength scan in the vicinity of the peak wavelength of the grating.

The optical circulator is, for example, the CR2500 model produced by JDS Fitel, and the optical spectrum analyser is the 8153A model produced by the Hewlett Packard Company.

The whole system is controlled by an electronic computer 80 which controls the action of the movement device 72, the tunable laser 77, the electronic circuit 75, and the optical spectrum analyser 79.

When the fibre component has reached the desired tension, in other words when the central wavelength of the grating, measured by means of a monitoring system described below, is equal to the desired value, the fibre can be fixed to the structure 1 by means of a second drop of epoxy resin on the other platform of the structure.

A measuring system such as that described above, in FIG. 4, was used to characterize an optical fibre filter based on a Bragg grating and assembled on a passive thermal compensation structure like that described above. In particular, the central element of the compensation structure was made from AISI 316 steel having a coefficient of thermal expansion of 1.6×10⁻⁵ 1/° C. The base support and the upper support of this structure are made from invar which has a coefficient of thermal expansion of 1.3×10⁻⁶ 1/° C. The optical fibre component is a Bragg grating of a commercial type, having a central reflection wavelength of 1535 nm and a sufficient bandwidth for channel spacing at 100 GHz as described above.

The component as a whole has an effective length (from one end 92 to the other end 93) of 47 mm, and the grating scribed inside it has a sensitivity to the effects of temperature which is quantifiable as a central wavelength shift of 11 pm/° C.

In these conditions, a length of the base support of 42 mm, a length of the upper support of 37 mm and a length of the central element of 32 mm were selected.

The results of this experiment are represented in FIG. 5, in which the wavelength shift of the spectral response of the filter is shown as a function of its temperature. The maximum shift was found to be less than 15 pm over a temperature range from 0° C. to +70° C.

FIG. 6 shows a comparison between the graph 81 of the shift of the spectral response for the optical fibre grating before assembly and the graph 82 of the corresponding shift of the spectral response after the assembly of the fibre on the compensation structure, for the same temperature range. The uncompensated grating has a total shift of more than 600 pm, while the maximum shift of the compensated grating is less than 15 pm. Consequently, the total variation of the wavelength shift is, for the case of the compensated device, at least one order of magnitude lower than in the case of the uncompensated device.

The present invention provides the following advantages.

The chosen configuration has the advantage of maximizing the ratio between the length of the compensated fibre component and the overall length of the structure. This permits a considerable reduction of the final dimensions of the assembly, since these are constrained only by the length of the optical fibre component. This is advantageous, for example, in underwater telecommunications systems, for which the components located in the submerged parts of the system have to occupy the smallest possible space.

At the same time, the particular “folded superimposed element” configuration makes it possible to use sufficiently long elements to obtain a high tolerance to errors of fabrication of the elements, to errors of mounting and to errors of the positioning and assembly of the fibre on the compensation structure. It is also possible to carry out a fine compensation after the component has been mounted in the structure, by lengthening or shortening the parts of the structure which are free to be elongated by the effect of a rise in temperature.

It is also possible to use all the available space of the fixing platforms 23 and 31 for the component 9, and consequently to extend the compensating action of the system simultaneously to a number N, greater than one, of optical fibre components. Typical values of N range from two to eight. The assembly of a plurality of components simultaneously on the same compensation structure is facilitated by the formation, on the fixing platforms, of the notches 32 and 23, preferably with a V-shaped cross section, which permit an ordered and equally spaced positioning of the fibre.

1. Structure capable of compensating for the effects of temperature variations on an optical fibre component, the said optical fibre component having at least a first end (92) and at least a second end (93), characterized in that the said structure comprises:
a first support capable of fixing the said first end (93) of the optical fibre component (9),
a second support capable of fixing the said second end (92) of the optical fibre component (9),
a central element (4) which connects the said first support to the said second support, having a coefficient of thermal expansion greater than that of both the said first support and the said second support, in such a way as to cause a variation of the distance between the said two ends of the component as the temperature varies.

2. Structure according to claim 1, characterized in that the said first support, the said second support and the said central element are at least partially superimposed on each other.

3. Structure according to claim 1, characterized in that the said central element (4) comprises a first portion connected to the said first support, a central portion which is free to change its length as a result of temperature variations, and a second central portion connected to the said second support.

4. Structure according to claim 3, characterized in that the said first portion of the central element (4) has a modifiable length.

5. Structure according to claim 3, characterized in that the said second portion of the central element (4) has a modifiable length.

6. Structure according to claim 1, characterized in that the said first support and the said second support have essentially the same coefficient of thermal expansion.

7. Structure according to claim 1, characterized in that the said first support is a base support (2) comprising, at one of its ends, a block (21) on whose upper surface (22) there is at least one V-shaped notch (23) into which one end (92) of the said component (9) can be inserted.

8. Structure according to claim 1, characterized in that the said second support is an upper support (3) comprising, at one of its ends, a platform (31) on which there is at least one V-shaped notch (32) into which one end (93) of the said component (9) can be inserted.

9. Structure according to claim 1, characterized in that the said central element comprises, in the said first portion, a first protuberance (41), which projects downwards, and is inserted into a hole (27) in the said base support (2), and, in the said second portion, a second protuberance (42) which projects upwards, and is inserted into a hole (36) in the said upper support (3).

10. Temperature-compensated optical fibre device, comprising a compensation structure according to one of the preceding claims and an optical fibre component fixed to the said structure.

11. Container (1) for optical fibre components (9), comprising an outer casing (11) into which the said structure for compensating for the effects of temperature variations according to claim 1 is inserted.

12. Method for compensating for the effects of temperature variations on an optical fibre component, the said optical fibre component having at least a first end (92) and at least a second end (93), comprising the following stages:
fixing the said first end to a first support,
tensioning the said component with a predetermined degree of tension;
fixing the said second end to a second support, connected to the said first support by means of a central element, the said central element comprising a first portion fixed to the said first support, a central portion free to change its length as a result of temperature variations, and a second central portion fixed to the said second support,
characterized in that it additionally comprises the stage of:
adjusting the length of the said central portion of the said central element.

13. Method according to claim 10, characterized in that the said stage of adjusting the length of the said central portion comprises welding the central element to the said first support in such a way as to extend the fixing area between the said first support and the said central element.

14. Method according to claim 10, characterized in that the said stage of adjusting the length of the said central portion comprises welding the central element to the said second support in such a way as to extend the fixing area between the said second support and the said central element.
